(19) United States
(12) Patent Application Publication
(10) Pub. No.: US 2023/0246259 A1
(43) Pub. Date: Aug. 3, 2023

(54) PROCESS FOR SEPARATING A MIXURE OF OXALATES OF TWO OR MORE OF NI, CO, AND MN

(71) Applicant: BASF SE, Ludwigshafen am Rhein (DE)

(72) Inventors: Jan Oliver Binder, Gießen (DE); Juergen Janek, Gießen (DE); Wolfgang G. Zeier, Muenster (DE); Sean Culver, Broomfield, CO (US)

(21) Appl. No.: 18/003,712

(22) PCT Filed: Jul. 2, 2021
(86) PCT No.: PCT/EP2021/068423

§ 371 Date: Dec. 29, 2022

(30) Foreign Application Priority Data
Jul. 2, 2020 (EP) 20183742.4
Jul. 27, 2020 (EP) 20187908.7

(51) Int. Cl. H01M 10/54; C22B 23/02; C01G 53/00

(52) U.S. Cl. CPC H01M 10/54; C22B 23/028; C01G 53/50; C01P 2002/50; C01P 2006/40

(57) ABSTRACT

The present disclosure is directed to processes for separating a mixture of oxalates of two or more of Ni (nickel), Co (cobalt) and Mn (manganese). Such processes are useful, for example, to separate recovery of two or more of Ni, Co and Mn from used ithium ion batteries or from waste of the production of lithium ion batteries or of cells or components of lithium ion batteries.

This application claims priority to European Patent Application Nos. 0183742.4, filed on Jul. 2, 2020, and 20187908.7, filed on Jul. 27, 2020; the contents of which are each incorporated herein by reference in its entirety.

The present disclosure relates generally to processes for separating a mixture of oxalates of two or more of Ni (nickel), Co (cobalt) and Mn (manganese). Such processes Are useful for separate recovery of two or more of Ni, Co and Mn from used lithium ion batteries or from waste of the production of lithium ion batteries or waste of the production of cells or components of lithium ion batteries or waste of the production of cathode active materials for lithium ion batteries. The process may also be useful for recovery of two or more of Ni, Co and Mn from electronics scrap. It is also useful for the recovery of two or more of Ni, Co and Mn from geogenic sources e.g., ores and ore concentrates.

Due to the wide-spread application of lithium ion batteries, a growing number of used lithium ion batteries is emerging. Used lithium ion batteries contain, inter alia, compounds of important transition metals like nickel, cobalt and manganese, and also lithium and compounds thereof. More specifically, the cathodes of lithium ion batteries often contain mixed oxides of lithium and one or more of nickel, cobalt and manganese as cathode active materials. Therefore, used lithium ion batteries may form a valuable source of raw materials for a new generation of lithium ion batteries. For that reason, increased research has been performed with the goal of recovering transition metals from used lithium ion batteries as well as from waste of the production of lithium ion batteries or waste of the production cells or components of lithium ion batteries or waste of the production of cathode active materials for lithium ion batteries. Used lithium ion batteries as well as waste of the production of lithium ion batteries, waste from the production of cells and of components of lithium ion batteries, and waste of the production of cathode active materials for lithium ion batteries are herein collectively referred to as “battery scrap”.

Various approaches have been proposed for recovery of transition metals from battery scrap. For example, one approach includes smelting of battery scrap followed by hydrometallurgical processing of the metallic alloy (matte) obtained from the smelting process. Another approach is the direct hydrometallurgical processing of battery scrap materials. Such hydrometallurgical processes will furnish transition metal compounds as aqueous solutions or in precipitated form, for example as hydroxides.

WO 2019/121086 A1 discloses a process for the recovery of transition metals from cathode active materials containing nickel and lithium, wherein the process comprises the steps of (a) treating a lithium containing transition metal oxide material with a leaching agent (preferably an acid selected from sulfuric acid, hydrochloric acid, nitric acid, methanesulfonic acid, oxalic acid and citric acid), (b) adjusting the pH value to 2.5 to 8, and (c) treating the solution obtained in step (b) with metallic nickel, cobalt or manganese or a combination of at least two of the foregoing. The process of WO 2019/121086 A1 typically yields an aqueous solution containing ions of Ni and one or more of Co and Mn, or precipitated mixed hydroxides, mixed oxyhydroxides or mixed carbonates of Ni and one or more of Co and Mn.

Battery scrap as defined above usually stems from multiple sources and therefore contains a broad variety of lithium transition metal oxides. Thus, battery scrap usually exhibits an ill-defined and fluctuating stoichiometric ratio between nickel, cobalt and manganese. In order to enable exploitation of battery scrap as a source for a new generation of high-quality cathode active materials, it is necessary to separate compounds of nickel, cobalt and manganese recovered from battery scrap so that they can be recombined in a stoichiometric ratio corresponding to the desired mixed oxide of Li and one or more of Ni, Co and Mn.

CN 109536724 A discloses a method for purifying cobalt and nickel based on a metal recycling process of waste batteries. Battery waste residue is dissolved in a sulfuric acid solution to obtain a solution containing nickel sulfate, cobalt sulfate, and a small amount of copper, iron, manganese, zinc and other impurities. The obtained solution is added to sodium sulfate, and the pH value in the solution is monitored as the reaction proceeds, and a weakly alkaline solution is added to change the pH value. After neutralization, the trivalent iron ions in the solution are reacted with sodium sulfate to form crystals. Then an alkyl phosphoric acid such as di-2-ethylhexyl phosphoric acid (D-2-EHPA) or an alkyl phosphate ester type extractant is used to extract the remaining copper, iron, manganese, zinc and other metal impurities in the solution so that a cobalt sulfate and nickel sulfate solution is obtained. Excess sodium hydroxide solution is added to the obtained cobalt sulfate and nickel sulfate solution until precipitation. When precipitation is found in the solution, the solution is filtered and the filtrate is again subject to the extraction step. Ammonium oxalate is added to the above-mentioned filtrate to precipitate both cobalt and nickel. The precipitate is filtered and evaporated to dryness. The cobalt oxalate and nickel oxalate precipitation mixtures obtained in the above steps are calcined at different temperatures to obtain cobalt oxide and nickel oxide powders. According to the slight difference between the properties of cobalt oxalate and nickel oxalate, cobalt and nickel are separated. More specifically, the calcination temperature reaches 380° C. to obtain nickel oxide, and the calcination temperature reaches 450° C. to obtain cobalt oxide.

Accordingly, separation of nickel oxalate and cobalt oxalate is based on their different thermal stability, and the teaching of CN 109536724 A requires a combination of liquid-phase treatment for simultaneous recovery of Ni and Co from battery scrap, and a thermal treatment for separation of Ni and Co from each other. For the sake of streamlining the process, it would be desirable that the separation of Ni and Co from each other could be achieved in the liquid phase, too.

In some embodiments, the present disclosure to provides a process, which allows for simultaneous recovery of two or more of Ni, Co and Mn from battery scrap or other waste and subsequent separation of the recovered Ni, Co and/or Mn by means of liquid phase treatment without the need for thermal treatment. Implementation of this process in the field of battery scrap recycling renders, e.g., the recovery of Ni, Co, and Mn from battery scrap more efficient.

Without limitation, some embodiments according to the present disclosure include:

Embodiment 1. A process for separating a mixture of oxalates of two or more of Ni, Co and Mn comprising the steps of:
(a) providing a mixture of oxalates of two or more of Ni, Co and Mn, and
(b) dissolving the mixture of oxalates in an acid to form a solution having a pH −0.5 or less,
wherein when the mixture of oxalates provided in step (a) comprises nickel oxalate, the process further comprises the following steps:
   (c) precipitating nickel oxalate by adjusting the pH of the solution formed in step (b) to a value ranging from 0.1 to 0.9 by adding a base, and
   (d) separating the precipitated nickel oxalate from the remaining solution of step (c) by solid/liquid separation,
   wherein when the mixture of oxalates provided in step (a) comprises cobalt oxalate, the process further comprises the following steps:
   (e) precipitating cobalt oxalate by adjusting the pH of the remaining solution from step (d) respectively of the solution formed in step (b) to a value ranging from 1 to 6 by adding a base, and
   (f) separating the precipitated cobalt oxalate from the remaining solution of step (e) by solid/liquid separation, wherein when the mixture of oxalates provided in step (a) comprises manganese oxalate, the process further comprises the following steps:
   (g) precipitating a precipitate of one or more of manganese oxalate, manganese hydroxide and manganese oxide by adjusting the pH of the remaining solution from step (d) respectively (f) to a value ranging from 8 to 14.5 by adding a base, and
   (h) separating the precipitate of one or more of manganese oxalate, manganese hydroxide and manganese oxide from the remaining solution of step (g) by solid/liquid separation.
      Embodiment 2. The process according to Embodiment 1, wherein separating a mixture of oxalates of Ni and Co comprises the steps of:
(a) providing a mixture of oxalates of Ni and Co,
(b) dissolving the mixture of oxalates in an acid to form a solution having a pH −0.5 or less,
(c) precipitating nickel oxalate by adjusting the pH of the solution formed in step (b) to a value ranging from 0.1 to 0.9 by adding a base,
(d) separating the precipitated nickel oxalate from the remaining solution of step (c) by solid/liquid separation,
(e) precipitating cobalt oxalate by adjusting the pH of the remaining solution of step (d) to a value ranging from 1 to 6 by adding a base, and
(f) separating the precipitated cobalt oxalate from the remaining solution of step (e) by solid/liquid separation.
   Embodiment 3. The process according to Embodiment 1, wherein separating a mixture of oxalates of Ni and Mn comprises the steps of:
(a) providing a mixture of oxalates of Ni and Mn,
(b) dissolving the mixture of oxalates in an acid to form a solution having a pH −0.5 or less,
(c) precipitating nickel oxalate by adjusting the pH of the solution formed in step (b) to a value ranging from 0.1 to 6 by adding a base,
(d) separating the precipitated nickel oxalate from the remaining solution of step (c) by solid/liquid separation,
(g) precipitating a precipitate of one or more of manganese oxalate, manganese hydroxide and manganese oxide by adjusting the pH of the remaining solution from step (d) to a value ranging from 8 to 14.5 by adding a base, and
(h) separating the precipitate of one or more of manganese oxalate, manganese hydroxide and manganese oxide from the remaining solution of step (g) by solid/liquid separation.

Embodiment 4. The process according to Embodiment 1, wherein separating a mixture of oxalates of Co and Mn comprises the steps of:
(a) providing a mixture of oxalates of Co and Mn,
(b) dissolving the mixture of oxalates in an acid to form a solution having a pH −0.5 or less,
(e) precipitating cobalt oxalate by adjusting the pH of the solution formed in step (b) to a value ranging from 1 to 6 by adding a base,
(f) separating the precipitated cobalt oxalate from the remaining solution of step (e) by solid/liquid separation,
(g) precipitating a precipitate of one or more of manganese oxalate, manganese hydroxide and manganese oxide by adjusting the pH of the remaining solution from step (f) to a value ranging from 8 to 14.5 by adding a base, and
(h) separating the precipitate of one or more of manganese oxalate, manganese hydroxide and manganese oxide from the remaining solution of step (g) by solid/liquid separation.
   Embodiment 5. The process according to any one of Embodiments 1-4, wherein step (b) comprises at least one of the following characteristics:
the mixture of oxalates is dissolved in an acid chosen from sulfuric acid, hydrochloric acid, and methanesulfonic acid;
the total concentration of Ni, Co and Mn in the solution formed in step (b) ranges from 1 g/l to 250 g/l;
the pH of the solution formed in step (b) ranges from −1 to −0.5;
in each of steps (c), (e) and (f), the pH is adjusted by adding a base independently chosen from LiOH, NaOH, KOH, and ammonia; and
in steps (d), (e) and (h), the solid/liquid separation is carried out by filtration, centrifugation, or sedimentation and decantation.
   Embodiment 6. The process according to any one of Embodiments 1-5, wherein:
in step (b), dissolving the mixture of oxalates by adding an aqueous solution of sulfuric acid with a concentration ranging from 20 wt % to 50 wt. % in an amount of from 20 ml to 100 ml per gram of the mixture of oxalates; and in each of steps (c), (e) and (g), adjusting the pH by adding an aqueous solution of NaOH or LiOH with a concentration ranging from 1 g/l to 500 g/l.
   Embodiment 7. The process according to any one of Embodiments 1-6, wherein step (a) providing the mixture of oxalates of two or more of Ni, Co and Mn comprises the sub-steps of:
(aa) preparing an aqueous reaction mixture containing ions of two or more of Ni, Co and Mn and oxalate ions, wherein the aqueous reaction mixture with a pH value ranging from 2 to 6,
(ab) reacting the aqueous reaction mixture to form a solid mixture of oxalates of two or more of Ni, Co and Mn, and
(ac) separating the formed solid mixture of oxalates of two or more of Ni, Co and Mn from the remaining aqueous reaction mixture by solid/liquid separation.
   Embodiment 8. The process according to Embodiment 7, wherein in sub-step (aa) preparing the aqueous reaction mixture comprises:
dissolving a mixture of two or more of Ni, Co and Mn in metallic form and/or in oxidized form in oxalic acid; or adding oxalate ions to an aqueous solution containing ions of two or more of Ni, Co and Mn,
wherein the solid material comprising a mixture of two or more of Ni, Co and Mn in metallic form and/or in oxidized form respectively and the solution comprising ions of two or more of Ni, Co and Mn are obtained from used lithium ion batteries or from waste of the production of lithium ion batteries, from waste of the production of cells or components of lithium ion batteries, or from waste of the production of cathode active materials for lithium ion batteries.
   Embodiment 9. The process according to Embodiments 7 or 8, wherein one or more of the following steps occur:
in sub-step (aa), preparing the aqueous reaction mixture comprising adding a reducing agent;
in sub-step (aa), adjusting the pH of the aqueous reaction mixture to a value ranging from 2 to 6 by adding a base chosen from LiOH, NaOH, KOH, and ammonia; and
in sub-step (ab), reacting the aqueous reaction mixture for 8 to 16 hours under continuous stirring at a temperature ranging from 10° C. to 200° C. to form a solid mixture of oxalates of two or more of Ni, Co and Mn, wherein at temperatures above 100° C. the reaction is performed at a pressure which is higher than 101.3 kPa, in sub-step (ac), carrying out the solid/liquid separation by filtration or centrifugation.
   Embodiment 10. The process according to any one of Embodiments 7 to 9, wherein in sub-step (aa) the aqueous reaction mixture is formed by:
dissolving a mixture of two or more of Ni, Co and Mn in metallic form and/or in oxidized form in an acid chosen from sulfuric acid, hydrochloric acid, citric acid, and methanesulfonic acid;
optionally adding a reducing agent chosen from hydrogen peroxide, hydrazine, primary alcohols, ascorbic acid, glucose, starch, cellulose, alkali metal sulfites, and sulfurous acid;
heating to a temperature ranging from 50° C. to 98° C.;
after the mixture of two or more of Ni, Co and Mn in metallic form and/or in oxidized form is dissolved, adding an aqueous solution of oxalic acid, wherein the amount of oxalic acid is equimolar or in molar excess relative to the total molar amount of Ni, Mn and Co in the solution, to form a solution containing oxalate ions and ions of two or more of Ni, Co and Mn; and
immediately adjusting the pH of the solution comprising oxalate ions and ions of two or more of Ni, Co and Mn to a value ranging from 2 to 6, such as 3 to 5 by adding a base chosen from LiOH, NaOH, KOH, and ammonia.
   Embodiment 11. The process according to Embodiment 10, the process further comprising one or more of the following:
dissolving a mixed oxide of two or more of Ni, Co and Mn by adding hydrochloric acid with a concentration ranging from 30 wt % to 40 wt % in an amount from 20 to 1000 times the solid mass;
adding an aqueous solution as the reducing agent, wherein the reducing agent comprises hydrogen peroxide with a concentration ranging from 1 wt % to 30 wt % in an amount from 0.2 vol % to 40 vol % with respect to the volume of hydrochloric acid added for dissolving the mixed oxide;
forming an aqueous solution by dissolving a mixed oxide of two or more of Ni, Co and Mn, wherein the total concentration of the dissolved Ni, Co and Mn ranges from 0.1 wt % to 20 wt %;
adding an aqueous solution of oxalic acid with a concentration ranging from 5 wt % to 30 wt % in an amount of from 105 mol % to 120 mol % oxalic acid relative to the molar amount of Ni, Mn and Co in the solution, wherein the pH of the solution prior to the addition of the base is in the range of from −0.5 to 1; and
adding an aqueous solution of NaOH or LiOH with a concentration ranging from 1 g/l to 500 g/l to adjust the pH to a value ranging from 3 to 5.
   Embodiment 12. The process according to any one of Embodiments 1 to 11, wherein the process further comprises the steps of
(i) mixing one or more of:
   nickel oxalate obtained in step (d),
   cobalt oxalate obtained in step (f), and
   manganese oxalate, manganese oxide and manganese hydroxide obtained in step (h),
wherein one or both of lithium carbonate and lithium hydroxide in a stoichiometric ratio corresponding to a mixed oxide of Li and one or more of Ni, Co and Mn and optionally with further constituents, and
(j) calcining the mixture to obtain a mixed oxide of Li and one or more of Ni, Co and Mn.
   Embodiment 13. The process according to Embodiment 12, wherein the mixed oxide has a composition according to the formula Li₁₊ₜ[CoₓMn_{y}Ni_{z}Mᵤ]₁₋ₜO₂, wherein
0≤x≤1
0≤y≤1
0≤z≤1
0≤u≤0.15
x+y+z+u=1
−0.05≤t≤0.2,
   and wherein if M is present, M comprises one or more elements selected from the group consisting of Al, Mg, Ba, B, and transition metals other than Ni, Co, and Mn.
   Embodiment 14. The process according to Embodiments 12 or 13, wherein the process further comprises one or more of the following steps:
in step (i), using lithium carbonate and/or lithium hydroxide obtained from used lithium ion batteries or from waste of the production of lithium ion batteries, cells and components of lithium ion batteries;
in step (j), calcining the mixture under oxygen atmosphere, un-der inert atmosphere, or under an atmosphere of a reducing gas; and
in step (j), calcining the mixture at a temperature ranging from 300° C. to 900° C. for a duration of from 0.5 h to 20 h.

These and other features, aspects, and advantages of the disclosure will be apparent from a reading of the following detailed description together with the accompanying drawings, which are briefly described below. The disclosure includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed disclosure, in any of its various aspects and embodiments, should be viewed as intended to be combinable unless the context clearly dictates otherwise.

### BRIEF DESCRIPTION OF THE DRAWINGS

To provide an understanding of embodiments of the disclosure, reference is made to the appended drawing, which is not necessarily drawn to scale. The drawing is provided as example only and should not be construed as limiting the scope of the disclosure.

FIG. 1 is an X-ray powder diffraction (XRD) of the precipitates obtained from Example 3, wherein the precipitate obtained in step (d) exhibited greenish color, the precipitate obtained in step (f) exhibited reddish color, and the precipitate obtained in step (h) exhibited black color.

The following terms, used in the present description and the appended claims, have the following definitions:

Expressions “a”, “an”, “the”, when used to define a term, include both the plural and singular forms of the term.

All percentages and ratios are mentioned by weight unless otherwise indicated.

As used herein, the term “about” means ±5% of the recited value inclusive of end points and the recited value.

In some embodiments, there is provided a process for separating a mixture of oxalates of two or more of nickel (Ni), cobalt (Co), and manganese (Mn), the process comprising the steps of
(a) providing a mixture of oxalates of two or more of Ni, Co and Mn, and
(b) dissolving the mixture of oxalates in an acid to form a solution with a pH −0.5 or less.

In addition to the steps above, in some embodiments, where the mixture of oxalates provided in step (a) comprises nickel oxalate, the process further comprises the steps of:
(c) precipitating nickel oxalate by adjusting the pH of the solution formed in step (b) to a value ranging from 0.1 to 0.9 by adding a base, and
(d) separating the precipitated nickel oxalate from the remaining solution of step (c) by solid/liquid separation.
When the mixture of oxalates provided in step (a) comprises cobalt oxalate, the process further comprises the steps of:
(e) precipitating cobalt oxalate by adjusting the pH of the remaining solution from step (d) respectively, of the solution formed in step (b) to a value ranging from 1 to 6 by adding a base, and
(f) separating the precipitated cobalt oxalate from the remaining solution of step (e) by solid/liquid separation.
When the mixture of oxalates provided in step (a) comprises manganese oxalate, the process further comprises the steps of:
(g) precipitating a precipitate of one or more of manganese oxalate, manganese hydroxide and manganese oxide by adjusting the pH of the remaining solution from step (d) respectively (f) to a value ranging from 8 to 14.5 by adding a base, and
(h) separating the precipitate of one or more of manganese oxalate, manganese hydroxide and manganese oxide from the remaining solution of step (g) by solid/liquid separation.
   From the process steps above, for example,
nickel oxalate obtained in step (d),
cobalt oxalate obtained in step (f)
manganese oxalate, manganese oxide and manganese hydroxide obtained in step (h) are collectively referred to as “the separated compounds of Ni, Co and Mn”.

In some embodiments, where the mixture of oxalates provided in step (a) comprises oxalates of Ni, Co and Mn, a process for separating the oxalates comprising steps (a) to (h) as defined above. Thus, a process according to the disclosure for separating a mixture of oxalates of Ni, Co and Mn comprises the steps of:
(a) providing a mixture of oxalates of Ni, Co and Mn,
(b) dissolving the mixture of oxalates in an acid to form a solution with a pH −0.5 or less,
(c) precipitating nickel oxalate by adjusting the pH of the solution formed in step (b) to a value ranging from 0.1 to 0.9 by adding a base,
(d) separating the precipitated nickel oxalate from the remaining solution of step (c) by solid/liquid separation,
(e) precipitating cobalt oxalate by adjusting the pH of the remaining solution from step (d) to a value ranging from 1 to 6 by adding a base,
(f) separating the precipitated cobalt oxalate from the remaining solution of step (e) by solid/liquid separation,
(g) precipitating a precipitate of one or more of manganese oxalate, manganese hydroxide and manganese oxide by adjusting the pH of the remaining solution from step (f) to a value ranging from 8 to 14.5 by adding a base, and
(h) separating the precipitate of one or more of manganese oxalate, manganese hydroxide and manganese oxide from the remaining solution of step (g) by solid/liquid separation.

In some embodiments where the mixture of oxalates provided in step (a) comprises oxalates of Ni and Co, while the oxalate of Mn is not present, steps (g) and (h) of the above-defined process are omitted. Thus, in some embodiments, a process according to the disclosure for separating a mixture of oxalates of Ni and Co, wherein the oxalate of Mn is not present in the mixture, comprises the steps of:
(a) providing a mixture of oxalates of Ni and Co,
(b) dissolving the mixture of oxalates in an acid to form a solution with a pH −0.5 or less,
(c) precipitating nickel oxalate by adjusting the pH of the solution formed in step (b) to a value ranging from 0.1 to 0.9 by adding a base,
(d) separating the precipitated nickel oxalate from the remaining solution of step (c) by solid/liquid separation,
(e) precipitating cobalt oxalate by adjusting the pH of the remaining solution of step (d) to a value ranging from 1 to 6 by adding a base,
(f) separating the precipitated cobalt oxalate from the remaining solution of step (e) by solid/liquid separation.

In some embodiments, where the mixture of oxalates provided in step (a) comprises oxalates of Ni and Mn, while the oxalate of Co is not present, steps (e) and (f) of the above-defined process are omitted. Thus, in some embodiments, a process according to the disclosure for separating a mixture of oxalates of Ni and Mn, wherein the oxalate of Co is not present in the mixture, comprises the steps of:
(a) providing a mixture of oxalates of Ni and Mn,
(b) dissolving the mixture of oxalates in an acid to form a solution with a pH −0.5 or less,
(c) precipitating nickel oxalate by adjusting the pH of the solution formed in step (b) to a value ranging from 0.1 to 6 by adding a base,
(d) separating the precipitated nickel oxalate from the remaining solution of step (c) of step (e) by solid/liquid separation,
(g) precipitating a precipitate of one or more of manganese oxalate, manganese hydroxide and manganese oxide by adjusting the pH of the remaining solution from step (d) to a value ranging from 8 to 14.5 by adding a base, and
(h) separating the precipitate of one or more of manganese oxalate, manganese hydroxide and manganese oxide from the remaining solution of step (g) by solid/liquid separation.

In some embodiments, where the mixture of oxalates provided in step (a) comprises oxalates of Co and Mn, while the oxalate of Ni is not present, steps (c) and (d) of the above-defined process are omitted. Thus, in some embodiments, a process according to the disclosure for separating a mixture of oxalates of Co and Mn wherein the oxalate of Ni is not present in the mixture, comprises the steps of:
(a) providing a mixture of oxalates of Co and Mn,
(b) dissolving the mixture of oxalates in an acid to form a solution with a pH −0.5 or less,
(e) precipitating cobalt oxalate by adjusting the pH of the solution formed in step (b) to a value ranging from 1 to 6 by adding a base,
(f) separating the precipitated cobalt oxalate from the remaining solution of step (e) by solid/liquid separation,
(g) precipitating a precipitate of one or more of manganese oxalate, manganese hydroxide and manganese oxide by adjusting the pH of the remaining solution from step (f) to a value ranging from 8 to 14.5 by addition of a base, and
(h) separating the precipitate of one or more of manganese oxalate, manganese hydroxide and manganese oxide from the remaining solution of step (g) by solid/liquid separation.

In some embodiments, in step (b) of the above-defined process according to the disclosure, a solid mixture of oxalates of two or more of Ni, Co and Mn provided in step (a) is dissolved by adding an acid to the solid mixture of oxalates. The acid may be chosen from sulfuric acid, hydrochloric acid, and methanesulfonic acid. For instance, in some embodiments, the mixture of oxalates is dissolved in sulfuric acid. The sulfuric acid may have a concentration ranging from 20 wt % to 50 wt %. In some further embodiments, in step (b) the mixture of oxalates is dissolved by adding an aqueous solution of sulfuric acid (with a concentration ranging of from 20 wt % to 50 wt %) in an amount of from 20 ml to 100 ml per gram of the mixture of oxalates.

In some embodiments, the transition metals (two or more of Ni, Co and Mn) present in the mixture of oxalates provided in step (a) respectively in the solution formed in step (b) may be identified and quantified by analysis of the mixture of oxalates provided in step (a) respectively in the solution formed in step (b) by suitable analytical methods, e.g., by optical emission spectroscopy using an inductively coupled plasma (ICP-OES). In some embodiments, another way of identifying the transition metals is x-ray fluorescence spectroscopy which upon calibration can also be employed for quantification. Thus, at the start of the process, it may be identified which of Ni, Co and Mn are present in the mixture of oxalates provided in step (a) respectively in the solution formed in step (b), and the process can be designed accordingly, e.g., by omitting those of steps (c) to (h) which are unnecessary because the corresponding oxalate is not present in the solid mixture of oxalates provided in step (a).

In some embodiments, the total concentration of Ni, Co and Mn in the solution formed in step (b) of the above-defined process according to the disclosure may be in the range of from 1 g/l to 250 g/l, such as from 10 g/l to 200 g/l, from 40 g/l to 160 g/l, from 60 g/l to 140 g/l, and from 80 g/l to 120 g/l. In some embodiments, the total concentration Ni, Co and Mn in the solution formed in step (b) of the above-defined process according to the disclosure may be in the range of from 10 g/l to 200 g/l.

In some embodiments, the pH of the solution formed in step (b) of the above-defined process according to the disclosure may be in the range of from -1 to -0.5.

In some further embodiments, in step (b) of the above-defined process according to the disclosure, a solution having a total concentration of Ni, Co and Mn ranging from 1 g/l to 250 g/l and a pH in ranging from −1 to −0.5 may be formed.

In some embodiments, in each of steps (c), (e) and (g) of the above-defined process according to the disclosure, the pH may be adjusted by adding a base independently chosen from LiOH, NaOH, KOH, and ammonia, in each case in the form of an aqueous solution. For the sake of reducing complexity, the same base may be used for steps (c), (e) and (g) of the above-defined process according to the disclosure. For instance, in some embodiments, in steps (c), (e) and (g) of the above-defined process according to the disclosure, the pH is adjusted by adding an aqueous solution of LiOH or NaOH. In further embodiments, in steps (c), (e) and (g), the pH is adjusted by adding an aqueous solution of NaOH or LiOH with a concentration ranging of from 1 g/l to 500 g/l, such as from 20 g/l to 480 g/l, from 40 g/l to 460 g/l, from 60 g/l to 440 g/l, from 80 g/l to 420 g/l, and from 100 g/l to 400 g/l. In other embodiments, in steps (c), (e) and (g), the pH is adjusted by adding an aqueous solution of NaOH or LiOH with a concentration ranging of from 20 g/l to 400 g/l.

In some embodiments, after the precipitation in steps (c), (e) and (g), respectively a solution remains (above the precipitate), and in step (d), (f) and (h), respectively, the precipitate is separated from the remaining solution of the preceding precipitation step by solid/liquid separation.

In some embodiments, in steps (d), (f) and (h) of the above-defined process according to the disclosure, the solid/liquid separation may be carried out by filtration, centrifugation, or sedimentation and decantation. For instance, in some embodiments, in steps (d), (f) and (h) of the above-defined process according to the disclosure, the solid/liquid separation is carried out by filtration.

After the solid/liquid separation in step (d) resp. (f), a solution remains, and the remaining solution is subject to a subsequent precipitation step (step (e) respectively step (g)).

In some embodiments, for example, each of the separated compounds of Ni, Co and Mn obtained in steps (d), (f) and (h) of the above defined process is washed up to three times with deionized water after the solid/liquid separation.

In some embodiments according to the above-defined disclosure:
The mixture of oxalates in step (b) is dissolved by adding an aqueous solution of sulfuric acid (with a concentration ranging from 20 wt % to 50 wt %) in an amount of from 20 ml to 100 ml per gram of the mixture of oxalates, and a solution with a total concentration of Ni, Co and Mn ranging from 1 g/l to 250 g/l and a pH ranging from −1 to −0.5 is formed
The pH of steps (c), (e) and (g) is adjusted by adding an aqueous solution of NaOH or LiOH with a concentration ranging from 1 g/l to 500 g/l, and/or
The solid/liquid separation in steps (d), (f) and (h) is carried out by filtration.

In some embodiments, the separated compounds of two or more of Ni, Co and Mn obtained by the above-defined process may exhibit different coloration and may be distinguished from each other by visual and/or optical means, because
Nickel oxalate obtained in step (d) typically exhibits greenish color;
Cobalt oxalate obtained in step (f) typically exhibits reddish color; and
Manganese oxalate, manganese oxide and manganese hydroxide obtained in step (h) typically exhibits black color.

Further identification of the structure and purity of the separated compounds of two or more of Ni, Co and Mn obtained by the above-defined process may be carried out by use of analytical methods like X-ray powder diffraction (XRD).

In some embodiments, according to the disclosure as defined above, providing the mixture of oxalates of two or more of Ni, Co and Mn (step (a)) may comprise the sub-steps of
(aa) preparing an aqueous reaction mixture comprising ions of two or more of Ni, Co and Mn and oxalate anions, wherein the aqueous reaction mixture with a pH value ranging from 2 to 6, such as, for example, 3 to 5;
(ab) reacting the aqueous reaction mixture to form a solid mixture of oxalates of two or more of Ni, Co and Mn; and/or
(ac) separating the formed solid mixture of oxalates of two or more of Ni, Co and Mn from the remaining aqueous reaction mixture by solid/liquid separation.

In some embodiments, in sub-step (aa), an aqueous reaction mixture comprising ions of two or more of Ni, Co and Mn and oxalate ions is formed.

In some embodiments, preparing the aqueous reaction mixture (sub-step (aa)) may comprise dissolving a mixture of two or more of Ni, Co and Mn in metallic form and/or in oxidized form in oxalic acid. The mixture may comprise mixed oxides of Ni and one or more of Co and Mn, precipitated mixed hydroxides, mixed oxyhydroxides or mixed carbonates of Ni and one or more of Co and Mn. In certain embodiments, the mixture is a mixed oxide of two or more of Ni, Co, and Mn.

In some embodiments, preparing the aqueous reaction mixture (step (aa)) may comprise adding oxalate ions to an aqueous solution comprising ions of two or more of Ni, Co and Mn. Herein, the source of oxalate ions may be chosen from oxalic acid, alkali metal oxalates, and ammonium oxalate.

In some embodiments, preparing the aqueous reaction mixture in sub-step (aa) may include adding a reducing agent. For example, by adding a reducing agent, the oxidation state of Ni, Co and Mn may be lowered, for instance from +3 to +2 respectively, from +4 to +3, or +2. The reducing agent may be chosen from hydrogen peroxide, hydrazine, primary alcohols, ascorbic acid, glucose, starch, cellulose, and alkali metal sulfites, and sulfurous acid. In some embodiments, for example, the reducing agent is hydrogen peroxide.

In some embodiments, in sub-step (aa), the pH of the aqueous reaction mixture may be adjusted to a value ranging from 2 to 6 by adding a base chosen from LiOH, NaOH, KOH, and ammonia.

In some embodiments, in sub-step (ab), the aqueous reaction mixture formed in sub-step (aa) is reacted to form a solid mixture of oxalates of two or more of Ni, Co and Mn. For instance, in sub-step (ab) the aqueous reaction mixture is reacted for 8 hours to 16 hours under continuous stirring at a temperature ranging from 10° C. to 200° C., such as from 20° C. to 200° C., to form a solid mixture of oxalates of two or more of Ni, Co and Mn. Reacting is usually affected by heating. When sub-step (ab) is performed at a temperature above 100° C. the reaction is performed at a pressure which is higher than 101.3 kPa (atmospheric pressure) to avoid evaporation of the liquid phase before the reaction is completed.

In some embodiments, in sub-step (ac), the solid/liquid separation may be carried out by filtration, centrifugation, or sedimentation and decantation. The solid mixture of oxalates obtained in sub-step (ac) may be washed up to, e.g., three times with deionized water after the solid/liquid separation.

In some embodiments, the mixture of oxalates of two or more of Ni, Co and Mn which is to be separated by the above-defined process according to the disclosure may be obtained from used lithium ion batteries or from waste of the production of lithium ion batteries or waste of the production of cells or components of lithium ion batteries, or waste of the production of cathode active materials for lithium ion batteries, or from other sources like electronics scrap or geogenic sources. As understood herein, waste of the production of lithium ion batteries or of cells or components of lithium ion batteries includes lithium ion batteries and cells and components of lithium ion batteries that do not meet the specifications and requirements, so-called off-spec materials. Used lithium ion batteries as well as waste of the production of lithium ion batteries, waste of the production of cells and of components of lithium ion batteries, and waste of the production of cathode active materials for lithium ion batteries are herein collectively referred to as “battery scrap”.

In some embodiments, the process according to the disclosure as described above may comprise upstream process steps (i.e., process steps preceding the above-defined process step (a), which are directed to obtaining (i) a solid material comprising a mixture of two or more of Ni, Co and Mn in metallic form and/or in oxidized form, or (ii) an aqueous solution containing ions of two or more of Ni, Co and Mn from battery scrap. The mixture of two or more of Ni, Co and Mn in metallic form and/or in oxidized form obtained from battery scrap respectively, the aqueous solution containing ions of two or more of Ni, Co and Mn obtained from battery scrap is then transferred into a mixture of oxalates of two or more of Ni, Co and Mn, wherein providing a mixture of oxalates of two or more of Ni, Co and Mn (step (a) of the process according to the disclosure as defined above). For example, the mixture of two or more of Ni, Co and Mn in metallic form and/or in oxidized form obtained from battery scrap or the aqueous solution containing ions of two or more of Ni, Co and Mn obtained from battery scrap may be transferred into a mixture of oxalates of two or more of Ni, Co and Mn by means of sub-steps (aa) to (ac) as defined above.

Thus, in sub-step (aa) of the process described herein, a solid material comprising a mixture of two or more of Ni, Co and Mn in metallic form and/or in oxidized form obtained from battery scrap respectively an aqueous solution comprising ions of two or more of Ni, Co and Mn obtained from battery scrap may be used to prepare the aqueous reaction mixture containing ions of two or more of Ni, Co and Mn and oxalate anions.

Processes for recovery of transition metals from battery scrap which provide a solid material comprising a mixture of two or more of Ni, Co, and Mn in metallic form and/or in oxidized form, or an aqueous solution containing ions of two or more of Ni, Co, and Mn, or precipitated mixed hydroxides, mixed oxyhydroxides or mixed carbonates of two or more of Ni, Co and Mn, or a mixed oxide of two or more of Ni, Co and Mn are known in the art.

Typically, such processes include e.g. disassembling and dismantling steps (for separation of housings, connectors, wirings, etc.), cell discharge, mechanical treatment (shredding, crushing, milling, grinding), solid/solid separation processes (classification, e.g., by a cyclone, magnetic separation, electrosorting, flotation for separating hydrophobic solids like electroconductive carbon and polymers from hydrophilic solids like metal oxides), extractions steps (e.g., solvent extraction to dissolve and remove organic salts and electrolyte additives as well as organic binders), leaching steps, solid-liquid separation steps (e.g., filtration, centrifugation, sedimentation and decantation), washing processes, and combinations thereof.

Such processes typically involve a stage/step where a solid mass containing one or more lithium transition metal oxides (from the cathode active material) and impurities is obtained. Such impurities may comprise one or more of electroconductive forms of carbon (e.g., graphite, carbon black, carbon nanofibers, graphene), copper and copper compounds, aluminum and aluminum compounds (e.g., alumina), iron and iron compounds, zinc and zinc compounds, silicon and silicon compounds, for example, silica and oxidized silicon SiO_{y} with 0<y<2, tin, silicon-tin alloys, precious metals (e.g., Ag, Au, Pd, Pt) and their compounds and organic polymers such as polyethylene, polypropylene, and fluorinated polymers, for example poly vinylidene fluoride (PVDF). Further examples of impurities are fluorides and compounds of phosphorous that may stem from liquid electrolytes, for example from the widely employed LiPF₆ and products stemming from the hydrolysis of LiPF₆. In recycling of battery scrap, such solid mass recovered from battery scrap is often referred to as the “black mass”.

By the solid-solid separation steps as disclosed above, a first solid fraction containing mainly lithium transition metal oxides (from the cathode active material) and other metals or metal compounds, and another fraction of solid material containing mainly carbonaceous and polymeric battery components can be recovered from the solid mass. Typical impurities which may be present in the first fraction are copper and copper compounds, aluminum and aluminum compounds (for example, alumina), iron and iron compounds, zinc and zinc compounds, silicon and silicon compounds, for example silica and oxidized silicon SiO_{y} with 0<y<2, tin, silicon-tin alloys, precious metals (e.g., Ag, Au, Pd, Pt) and their compounds, fluorides and compounds of phosphorous that may stem from liquid electrolytes, for example in the widely employed LiPF₆ and products stemming from the hydrolysis of LiPF₆.

In some embodiments, the first fraction—after separation of those constituents which are not Ni, Co or Mn in metallic form respectively in oxidized form—may be the source of the mixture of two or more of Ni, Co and Mn in metallic form and/or in oxidized form respectively of the aqueous solution containing ions of two or more of Ni, Co and Mn used for preparing the aqueous reaction mixture in sub-step (aa). Separation of impurities may be achieved by, e.g., thermal treatment, leaching, precipitation, re-dissolution of precipitates, cementation, solvent extraction, ion exchange extraction, and combinations thereof.

In some embodiments, a process for recovery of lithium salts and a mixture of two or more of Ni, Co, and Mn in metallic form and/or in oxidized form from battery scrap involves thermal decomposition of lithium transition metal oxides (cathode active material) into the following:
lithium salts (for instance, but not limited to one or more of LiOH, Li₂O, Li₂CO₃, LiF, Li₃PO₄, LiAlO₂, wherein Li salts containing F, Al and/or P may stem from reaction with other constituents of the battery scrap which contain F, Al and/or P, e.g., organic binders, electrolyte salts like LiPF6, current collectors and housings made of aluminum); and
a mixture containing two or more of Ni, Co, and Mn in metallic form and/or in oxidized form, and
subsequent dissolution of the lithium salts and separation of the mixture containing two or more of Ni, Co, and Mn in metallic form and/or in oxidized form by solid/liquid separation.

In some embodiments, where the mixture contains two or more of Ni, Co and Mn in oxidized form, the mixture may be a mixed oxide of two or more of Ni, Co, and Mn. An exemplary process for recovery of lithium salts and a mixed oxide of Ni, Co, and Mn from used cathodes involves thermal decomposition of a lithium transition metal oxide into lithium salts and a mixed oxide of Ni, Co and Mn, subsequent dissolution of the lithium salts and separation of the mixed oxide of Ni, Co and Mn by solid/liquid separation is described in the example section.

The mixture of two or more of Ni, Co and Mn in metallic form and/or in oxidized form may be dissolved in an acid, e.g., in an acid chosen from sulfuric acid, hydrochloric acid, citric acid, and methanesulfonic acid to form an aqueous solution containing ions of two or more of Ni, Co and Mn, which may be used for preparing an aqueous reaction mixture containing ions of two or more of Ni, Co, and Mn and oxalate anions, the aqueous reaction mixture having a pH ranging from 2 to 6 (e.g., sub-step (aa)).

In some embodiments, processes for recovering transition metals from battery scrap do not involving thermal treatment, for the reasons provided above.

For example, WO 2019/121086 A1 discloses a process for the recovery of transition metals from cathode active materials, by which an aqueous solution containing ions of Ni and one or more of Co and Mn, or precipitated mixed hydroxides, mixed oxyhydroxides or mixed carbonates of Ni and one or more of Co and Mn is obtained. The process described in WO 2019/121086 A1 does not require thermal treatment.

Thus, for example, an aqueous solution containing ions of Ni and one or more of Co and Mn obtained by the process described in WO 2019/121086 A1 may be used to prepare the aqueous reaction mixture in sub-step (aa). Alternatively, in some embodiments, an aqueous solution containing ions of Ni and one or more of Co and Mn formed by re-dissolving a precipitate of mixed hydroxides, mixed oxyhydroxides or mixed carbonates of Ni and one or more of Co and Mn obtained by the process described in WO 2019/121086 A1 may be used to prepare the aqueous reaction mixture in sub-step (aa). The aqueous reaction mixture is obtained by adding a source of oxalate ions which may be chosen from oxalic acid, alkali metal oxalates, and ammonium oxalate to the aqueous solution containing ions of Ni and one or more of Co and Mn. Further alternatively, in some embodiments, in sub-step (aa) the aqueous reaction mixture may be prepared by dissolving a precipitate of hydroxides, mixed oxyhydroxides or mixed carbonates of Ni and one or more of Co and Mn obtained by the process described in WO 2019/121086 A1 in oxalic acid.

In some embodiments, according to the disclosure, preparing the aqueous reaction mixture (e.g., sub-step (aa)) comprises dissolving a mixture of two or more of Ni, Co and Mn in metallic form and/or in oxidized form (e.g., a mixed oxide of two or more of Ni, Co and Mn) in an acid different from oxalic acid, optionally in the presence of a reducing agent, so that an aqueous solution containing ions of two or more of Ni, Co and Mn is obtained. After the mixture of two or more of Ni, Co, and Mn in metallic form and/or in oxidized form is dissolved, an aqueous reaction mixture as defined above is prepared by adding oxalate ions to the obtained solution containing ions of two or more of Ni, Co, and Mn.

In some embodiments, the mixture of two or more of Ni, Co, and Mn in metallic form and/or in oxidized form (e.g., a mixed oxide of two or more of Ni, Co and Mn) may be provided in the form of a constituent of a solid mass which further comprises other solid constituents recovered from battery scrap, e.g., electroconductive forms of carbon like graphite, carbon black, carbon nanofibers, or graphene, and further impurities as defined above. Those components of the above-defined solid mass which do not dissolve in the acid used for dissolving the mixture of two or more of Ni, Co, and Mn in metallic form and/or in oxidized form may be separated by solid/liquid separation from the obtained aqueous solution containing ions of two or more of Ni, Co and Mn before oxalate ions are added to the obtained aqueous solution containing ions of two or more of Ni, Co and Mn. Herein, solid/liquid separation may be carried out by, e.g., filtration, centrifugation, or sedimentation and decantation.

In some embodiments, the mixture of two or more of Ni, Co, and Mn in metallic form and/or in oxidized form (e.g., a mixed oxide of two or more of Ni, Co and Mn) may be dissolved in an acid chosen from sulfuric acid, hydrochloric acid, citric acid, and methanesulfonic acid, and the reducing agent—if present—may be chosen from hydrogen peroxide, hydrazine, primary alcohols, ascorbic acid, glucose, starch, cellulose and alkali metal sulfites and sulfurous acid. In some embodiments, in case all the two or more of Ni, Co and Mn is present in metallic form a reducing agent is usually not added.

In some embodiments, for instance, the acid is hydrochloric acid. The hydrochloric acid may have a concentration ranging from 30 wt % to 40 wt %. For example, the mixture of two or more of Ni, Co and Mn in metallic form and/or in oxidized form (e.g., a mixed oxide of two or more of Ni, Co and Mn) may be dissolved by adding hydrochloric acid in the form of an aqueous solution (having a concentration of HCl ranging from 30 wt % to 40 wt %) in an amount of from 20 to 1000 times the solid mass comprising a mixed oxide of two or more of Ni, Co and Mn.

In some embodiments, for instance, the reducing agent is hydrogen peroxide. The hydrogen peroxide may have a concentration in the range or from 1 wt % to 30 wt %. For example, an aqueous solution of hydrogen peroxide (having a concentration ranging from 1 wt % to 30 wt %) is added in an amount of from 0.2 vol % to 40 vol % with respect to the volume of acid added for dissolving the mixture of two or more of Ni, Co, and Mn in metallic form and/or in oxidized form.

In some embodiments, dissolving the mixture of two or more of Ni, Co, and Mn in metallic form and/or in oxidized form may be promoted by heat. For example, dissolving a mixed oxide of two or more of Ni, Co, and Mn in an acid different from oxalic acid is carried out at a temperature ranging from 50° C. to 98° C.

For example, in some embodiments, the mixture of two or more of Ni, Co and Mn in metallic form and/or in oxidized form (e.g., a mixed oxide of two or more of Ni, Co and Mn) may be dissolved by adding hydrochloric acid (having a concentration ranging from 30 wt % to 40 wt %) in an amount of from 20 to 1000 times the solid mass, and as the reducing agent hydrogen peroxide in the form of an aqueous solution (having a concentration of H₂O₂ ranging from 1 wt % to 30 wt %) may be added in an amount of from 0.2 vol % to 40 vol % with respect to the volume of hydrochloric acid added for dissolving the mixture of two or more of Ni, Co and Mn in metallic form and/or in oxidized form, and heating to a temperature ranging from 50° C. to 98° C.

The total concentration of dissolved Ni, Co and Mn in the aqueous solution formed by dissolving the mixture of two or more of Ni, Co and Mn in metallic form and/or in oxidized form (e.g., a mixed oxide of two or more of Ni, Co and Mn) may be in the range of from 0.1 wt % to 20 wt %, based on the total weight of the solution. The concentration of each of Ni, Co and Mn may be determined by suitable analytical methods, e.g., by optical emission spectroscopy using an inductively coupled plasma (ICP-OES). Further for example, another way of identifying Ni, Co, and Mn is x-ray fluorescence spectroscopy which upon calibration can also be employed for quantification.

In some embodiments, after the mixture of two or more of Ni, Co, and Mn in metallic form and/or in oxidized form, (e.g., a mixed oxide of two or more of Ni, Co, and Mn) is dissolved, oxalate ions are added to the obtained aqueous solution containing ions of two or more of Ni, Co and Mn. For instance, in some embodiments, the oxalate ions are added 0.1 to 4 hours after dissolving the mixture of two or more of Ni, Co and Mn in metallic form and/or in oxidized form in acid, or immediately after dissolving the mixture of two or more of Ni, Co and Mn in metallic form and/or in oxidized form in acid. The source of oxalate ions may be chosen from oxalic acid, alkali metal oxalates and ammonium oxalate. For example, the source of oxalate ions is oxalic acid. Herein, oxalic acid is added in equimolar amount or in molar excess relative to the total molar amount Ni, Mn, and Co in the aqueous solution. The oxalic acid may be in the form of an aqueous solution with a concentration ranging from 5 wt % to 30 wt % oxalic acid. Further for example, an aqueous solution of oxalic acid with a concentration ranging from 5 wt % to 30 wt % may be added in an amount of from 105 to 120 mol % oxalic acid relative to the molar amount of relative to the molar amount of Ni, Mn and Co in the aqueous solution.

In some embodiments, immediately after adding the source of oxalate anions, the pH of the aqueous solution comprising oxalate ions and ions of two or more of Ni, Co and Mn is adjusted to a pH value ranging from 2 to 6, such as 3 to 5 by adding a base. Before addition of the base, the pH of the aqueous solution is typically in the range of from −0.5 to 1. The base may be chosen from LiOH, NaOH, KOH, and ammonia. For example, in some embodiments, the base is LiOH or NaOH. Herein, the pH may be adjusted by adding NaOH or LiOH with a concentration ranging from 1 g/l to 500 g/l. Further for example, the pH may be adjusted to a value ranging from 3 to 5 by adding an aqueous solution of NaOH or LiOH with a concentration ranging from 1 g/l to 500 g/l.

In some embodiments of the disclosed process, in sub-step (aa) an aqueous reaction mixture is formed by:
dissolving a mixed oxide of two or more of Ni, Co, and Mn by adding hydrochloric acid (with a concentration ranging from 30 wt % to 40 wt %) in an amount of from 20 to 1000 times the solid mass and an aqueous solution of hydrogen peroxide (with a concentration ranging from 1 wt % to 30 wt %) in an amount of from 0.2 vol % to 40 vol % with respect to the volume of acid added for dissolving the mixed oxide,
heating the mixture to a temperature range from 50° C. to 98° C.,
adding an aqueous solution of oxalic acid after the mixed oxide is dissolved, with a concentration ranging from 5 wt % to 30 wt % in an amount of from 105 mol % to 120 mol % oxalic acid relative to the molar amount of Ni, Mn and Co in the solution, to form a solution containing oxalate ions and ions of two or more of Ni, Co and Mn, wherein the total concentration of dissolved Ni, Co and Mn in the aqueous solution formed by dissolving a mixed oxide of two or more of Ni, Co and Mn may be in the range of from 0.1 wt % to 20 wt %, and
immediately adjusting the pH of the solution containing oxalate ions and ions of two or more of Ni, Co and Mn to a value ranging from 3 to 5 by adding an aqueous solution of NaOH or LiOH with a concentration ranging from 1 g/l to 500 g/l.

In some embodiments, the separated compounds of two or more of Ni, Co and Mn obtained by the above-defined process according to the disclosure may be used either alone or admixed in the desired stoichiometry for producing cathode active materials for lithium ion batteries. Thus, in some embodiments, a process according to the disclosure may comprise additional steps directed to the production of new cathode active materials for lithium ion batteries, wherein one or more of the separated compounds of two or more of Ni, Co and Mn is applied as a starting material for producing a cathode active material for lithium ion batteries.

For example, a process comprising above-defined steps (a)-(h), or (a)-(f), or (a)-(d) and (g)-(h), or (a)-(b) and (e)-(h) may comprise the additional steps:

(i) mixing one or more of
nickel oxalate obtained in step (d),
cobalt oxalate obtained in step (f), and
manganese oxalate, manganese oxide and manganese hydroxide obtained in step (h),

wherein one or both of lithium carbonate and lithium hydroxide, and optionally with further constituents in a stoichiometric ratio corresponding to a mixed oxide of Li and one or more of Ni, Co and Mn and optionally one or more further elements, and

(j) calcining the mixture to obtain a mixed oxide of Li and one or more of Ni, Co and Mn and optionally one or more further elements.

In some embodiments, in step (i) further constituents may be admixed, e.g., one or more compounds of Ni, Mn and/or Co obtained from other sources.

In addition, one or more further constituents which serve as a source of one or more elements M other than Li, Ni, Co, and Mn may be admixed in step (i). Thus, a cathode active material may be obtained which is a mixed oxide of Li, one or more of Ni, Co and Mn and one or more elements M other than Li, Ni, Co, and Mn. Suitable further constituents which may serve as a source of one or more elements M for a cathode active material are known in the art.

Thus, in some embodiments, in step (i), one or more of
nickel oxalate obtained in step (d),
cobalt oxalate obtained in step (f), and
manganese oxalate, manganese oxide and manganese hydroxide obtained in step (h),
   may be mixed with one or both of lithium carbonate and lithium hydroxide, and optionally with further constituents in a stoichiometric ratio corresponding to the desired mixed oxide of Li and one or more of Ni, Co, and Mn and optionally one or more elements M other than Ni, Co, and Mn.

In some embodiments, in step (i), lithium carbonate and/or lithium hydroxide obtained from used lithium ion batteries or from waste of the production of lithium ion batteries, cells and components of lithium ion batteries may be used.

In some embodiments, in step (j), calcining of the mixture may be carried out under oxygen containing atmosphere or under an inert atmosphere e.g., under nitrogen. The calcination may be also done under carbon dioxide atmosphere, or under an atmosphere of a reducing gas, e.g., hydrogen or carbon monoxide or a mixture of hydrogen and carbon monoxide. Also, a change of atmosphere may be feasible e.g., calcining first under nitrogen and second under oxygen containing atmosphere or a reducing atmosphere.

In some embodiments, in step (j), calcining of the mixture may be carried out a temperature ranging from 300° C. to 900° C. for a duration of from 0.5 h to 20 h.

For instance, the mixed oxide obtained in step (j) may have a composition according to general formula (I):

Li₁₊ₜ[CoₓMn_{y}Ni_{z}Mᵤ]₁₋ₜO₂ (I)

wherein

0≤x≤1

0≤y≤1

0≤z≤1

0≤u≤0.15

x+y+z+u=1

−0.05≤t≤0.2,

wherein M if present is one or more elements chosen from Al, Mg, Ba, B, and transition metals other than Ni, Co, and Mn.

In some embodiments, in cathode active materials according to general formula (I) the elements M other than Ni, Co, and Mn are chosen from Al, Mg, Ti, Mo, Nb, W and Zr. For example, the cathode active material according to general formula (I) contains one or more of Ni and Mn. In certain cathode active materials according to general formula (I), M may be one of Al, Ti, Mo, Nb, W and Zr. Exemplary cathode active materials of formula (I) are Li₁₊ₜ[Ni_{0.88}Co_{0.08}Al_{0.04}]₁₋ₜO₂, Li₁₊ₜ[Ni_{0.905}Co_{0.0475}Al_{0.0475}]₁₋ₜO₂, and Li₁₊ₜ[Ni_{0.91}Co_{0.045}Al_{0.045}]₁₋ₜO₂, wherein in each case −0.05≤t≤0.2.

It is understood that cathode active materials according to general formula (I) wherein one or more elements M chosen from Al, Mg, Ba, B, and transition metals other than Ni, Co, and Mn is present (i.e., in formula (I) 0<u≤0.15) are obtainable by a process as defined above wherein step (i) includes addition of further constituents which may serve as the source of the one or more elements M chosen from Al, Mg, Ba, B, and transition metals other than Ni, Co, and Mn, i.e., by a process comprising the above-defined steps (a)-(h), or (a)-(f), or (a)-(d) and (g)-(h), or (a) (b) and (e)-(h), and the additional steps

(i) mixing one or more of
nickel oxalate obtained in step (d),
cobalt oxalate obtained in step (f), and
manganese oxalate, manganese oxide and manganese hydroxide obtained in step (h),
with one or both of lithium carbonate and lithium hydroxide, and
one or more further constituents which may serve as the source of one or more elements M chosen from Al, Mg, Ba, B, and transition metals other than Ni,

Co, and Mn in a stoichiometric ratio corresponding to a mixed oxide of Li and one or more of Ni, Co, and Mn and one or more elements M as defined above, and

(j) calcining the mixture to obtain a mixed oxide of Li and one or more of Ni, Co and Mn and one or more elements M as defined above.

In some embodiments, the mixed oxide obtained in step (j) may have a composition according to general formula (Ia):

Li₁₊ₜ[CoₓMn_{y}Ni_{z}]₁₋ₜO₂ (Ia)

wherein

0≤x≤1

0≤y≤1

0≤z≤1

x+y+z=1

−0.05≤t≤0.2.

Exemplary cathode active materials according to general formula (Ia) are LiCoO₂, Li₁₊ₜ[Ni_{0.85}Co_{0.10}Mn_{0.04}]₁₋ₜO₂, Li₁₊ₜ[Ni_{0.85}Mn_{0.10}Co_{0.04}]₁₋ₜO2, Li₁₊ₜ[Ni_{0.87}Co_{0.05}Mn_{0.08}]₁₋ₜO₂, Li₁₊ₜ[Ni_{0.83}Co_{0.12}Mn_{0.05}]₁₋ₜO2, and Li₁₊ₜ[Ni_{0.6}Mn_{0.2}Co_{0.2}]₁₋ₜO₂ (NMC622).

It is understood that cathode active materials according to general formula (Ia) are obtainable by a process as defined above wherein step (i) does not include addition of further constituents which may serve as the source of one or more elements M as defined above, i.e., by a process comprising above-defined steps (a)-(h), or (a)-(f), or (a)-(d) and (g)-(h), or (a)-(b) and (e)-(h), and the additional steps:

(i) mixing one or more of
nickel oxalate obtained in step (d),
cobalt oxalate obtained in step (f), and
manganese oxalate, manganese oxide and manganese hydroxide obtained in step (h)
with one or both of lithium carbonate and lithium hydroxide in a stoichiometric ratio corresponding to a mixed oxide of Li and one or more of Ni, Co, and Mn, and

(j) calcining the mixture to obtain a mixed oxide of Li and one or more of Ni, Co, and Mn.

The disclosure is further illustrated by a working example which however is not limiting.

### EXAMPLES

### Example 1

### Recovery of Li₂CO₃ and a Mixed Oxide of Ni, Co, and Mn from Used Cathodes

The cathode layers (comprising LiNi_{0.8}Co_{0.1}Mn_{0.1}O₂ as the cathode active material, electronically conductive carbon and an organic binder) of used cathodes were separated from the current collectors by mechanical treatment.

The obtained mixture comprising LiNi_{0.8}Co_{0.1}Mn_{0.1}O₂, electronically conductive carbon and an organic binder is calcined for about 12 hours at about 500° C. under oxygen atmosphere so that the organic materials and the electronically conductive carbon were removed by thermal decomposition and combustion.

By further thermal treatment under carbon dioxide atmosphere for about 60 hours at about 600° C. the cathode active material LiNi0.8Co0.1Mn0.1O2 was decomposed into lithium carbonate Li₂CO₃ and a mixed oxide of Ni, Co, and Mn, Ni_{0.8}Co_{0.1}Mn_{0.1}O₂:

2 LiNi_{0.8}Co_{0.1}Mn_{0.1}O₂+CO₂→Li₂CO₃+2 Ni_{0.8}Co_{0.1}Mn_{0.1}O₂+0.5 O₂

The obtained mixture comprising Li₂CO₃, optionally LiF (fluorine probably originating form fluorine-containing polymers which are commonly used as organic binders) and Ni_{0.8}Co_{0.1}Mn_{0.1}O₂ was transferred into ice-cooled water enriched with carbon dioxide and stirred for ₅ hours so that the Li salts dissolve. Herein, poorly soluble Li₂CO₃ was dissolved as LiHCO₃. The remaining undissolved Ni_{0.8}Co_{0.1}Mn_{0.1}O₂ was separated from the solution by filtration.

Ca(OH)₂ was added to the filtrate, resulting in precipitation of CaCO₃ and—in case LiF was present—CaF₂, which were separated from the remaining solution of LiOH by filtration. LiOH was transformed into Li₂CO₃ by introduction of carbon dioxide. The obtained Li₂CO₃ may be used in step (i) of the process according to the present disclosure.

Alternatively, a solid fraction containing one or more mixed oxides of lithium and at least two of Ni, Co and Mn obtained from battery scrap may be treated by the process described in WO 2019/121086 to recover Li in the form of Li₂CO₃ and/or LiOH, and Ni, Co and Mn in the form of an aqueous solution containing ions of Ni and one or more of Co and Mn, or precipitated mixed hydroxides, mixed oxyhydroxides or mixed carbonates of Ni and one or more of Co and Mn.

### Example 2

### Preparation of a Mixture of Oxalates of Two or More of Ni, Co and Mn (Step (a) of the Process According to the Present Disclosure)

The mixed oxide Ni_{0.8}Co_{0.01}Mn_{0.1}O₂ obtained as described in Example 1 was used for preparing an aqueous reaction mixture containing ions of two or more of Ni, Co and Mn and oxalate ions (sub-step (aa)). Hereto, 100 mg of the separated mixed oxide Ni_{0.8}Co_{0.1}Mn_{0.1}O₂ was dissolved in 50 ml concentrated hydrochloric acid (37 wt %) and 5 ml (30 wt %) H₂O₂ at about 60° C. About 2-3 hours later oxalic acid was added to the obtained aqueous solution in an amount of from 105 mol % to 120 mol % oxalic acid relative to the molar amount of Ni, Mn and Co in the solution, and immediately the pH of the obtained solution containing ions of Ni, Co and Mn and oxalate ions was adjusted to a value of about 4 by adding an aqueous solution of NaOH or LiOH. Thus, an aqueous reaction mixture containing ions of Ni, Co and Mn and oxalate ions was obtained (sub-step (aa)).

Alternatively, an aqueous solution containing ions of Ni and one or more of Co and Mn obtained by dissolving a mixture of two or more of Ni, Co and Mn in metallic form and/or in oxidized form (obtained from battery scrap) in an acid may be used to prepare the aqueous reaction mixture in sub-step (aa).

For instance, an aqueous solution containing ions of Ni and one or more of Co and Mn obtained by the process described in WO 2019/l21086 A1 may be used to prepare the aqueous reaction mixture in sub-step (aa); or an aqueous solution containing ions of Ni and one or more of Co and Mn formed by re-dissolving a precipitate of mixed hydroxides, mixed oxyhydroxides or mixed carbonates of Ni and one or more of Co and Mn obtained by the process described in WO 2019/121086 A1 may be used to prepare the aqueous reaction mixture in sub-step (aa). Herein, the aqueous reaction mixture is obtained by adding a source of oxalate ions which may be selected from oxalic acid, alkali metal oxalates and ammonium oxalate to the aqueous solution containing ions of Ni and one or more of Co and Mn. Further alternatively, in sub-step (aa) the aqueous reaction mixture may be prepared by dissolving a precipitate of hydroxides, mixed oxyhydroxides or mixed carbonates of Ni and one or more of Co and Mn obtained by the process described in WO 2019/121086 A1 in oxalic acid.

The aqueous reaction mixture was reacted at a temperature of about 60° C. for about 12 hours under stirring to form a solid mixture of oxalates of Ni, Co and Mn (sub-step (ab)). The obtained mixture of oxalates of Ni, Co and Mn was separated from the remainder of the aqueous reaction mixture by filtration (sub-step (ac)) and washed three timed with deionized water.

### Example 3

### Separation of a Mixture of Oxalates of Ni, Co, and Mn (Steps (b)-(h) of the Process According to the Present Disclosure)

The mixture of oxalates of Ni, Co and Mn provided in step (a) as described above was dissolved in 3.75 M sulfuric acid (step (b)). The amount of added 3.75 M sulfuric acid was about 50 ml per g of solid mixture of oxalates.

Nickel oxalate was precipitated by adjusting the pH of the solution formed in step (b) to 0 by adding an aqueous solution of NaOH or LiOH (step (c)), and the precipitated nickel oxalate was separated from the remaining solution of step (c) by solid/liquid separation (step (d)).

Cobalt oxalate was precipitated by adjusting the pH of the solution remaining after step (d) to 1.5 by further adding an aqueous solution of NaOH or LiOH (step (e)), and the precipitated cobalt oxalate was separated from the remaining solution of step (e) by solid/liquid separation (step (f)).

A mixed precipitate of manganese oxalate and manganese hydroxide was precipitated by adjusting the pH of the solution remaining after step (f) to 14 by further adding an aqueous solution of NaOH or LiOH (step (g)), and the precipitate was separated from the remaining solution of step (g) by solid/liquid separation (step (h)).

Each of the separated compounds of Ni, Co, and Mn obtained in steps (d), (f) and (h) was washed three times with deionized water after the solid/liquid separation.

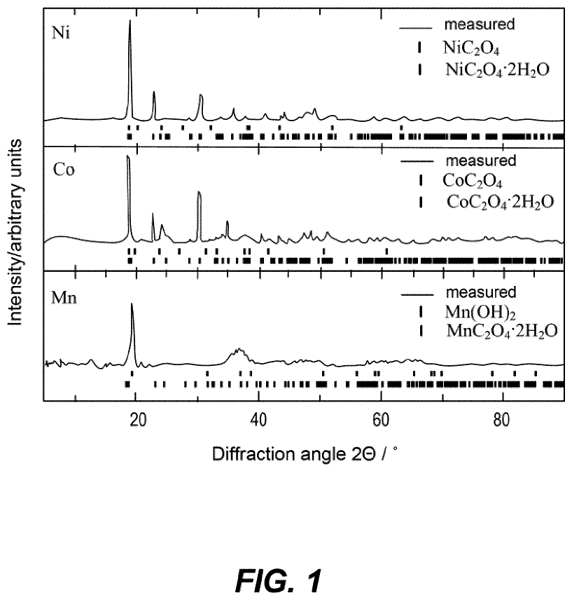

The precipitate obtained in step (d) exhibited greenish color. The precipitate obtained in step (f) exhibited reddish color. The precipitate obtained in step (h) exhibited black color. Each precipitate was characterized by XRD analysis (FIG. 1). The intensity was given in arbitrary units. The diffractogram of the Ni compound (denoted as “Ni”) exhibited reflexes of nickel oxalate and nickel oxalate dihydrate. The vertical ticks below the measured pattern in the diffractogramm denoted “Ni” were calculated reflexes of NiC₂O₄ (upper row) resp. NiC₂O₄*2H₂O (lower row). The diffractogram of the Co compound (denoted as “Co”) exhibited reflexes of cobalt oxalate and cobalt oxalate dihydrate. The vertical ticks below the measured pattern in the diffractogramm denoted “Co” were calculated reflexes of CoC₂O₄ (upper row) resp. CoC₂O₄*2H₂O (lower row). The diffractogram of the Mn compound (denoted “Mn”) exhibited reflexes of manganese hydroxide and manganese oxalate dihydrate (lower row). The vertical ticks below the measured pattern in the diffractogram denoted “Mn” were calculated reflexes of Mn(OH)₂ (upper row) resp. MnC₂O₄*2H₂O (lower row).

### Example 4

### Preparation of New Cathode Active Material (Steps (i) and (j) of the Process According to the Present Disclosure)

The precipitates obtained as described in Example 3 and Li₂CO₃ obtained as described in Example 1 were mixed according to the stoichiometry of a cathode active material of formula (Ia) as defined above (step (i)) and calcined at about 800° C. under oxygen atmosphere (step (j)).

1. A process for separating a mixture of oxalates of two or more of nickel (Ni), cobalt (Co), and manganese (Mn), comprising the steps of:
(a) providing a mixture of oxalates of two or more of Ni, Co, and Mn, and
(b) dissolving the mixture of oxalates in an acid to form a solution having a pH of −0.5 or less,
wherein when the mixture of oxalates provided in step (a) comprises nickel oxalate, the process further comprises the following steps:
(c) precipitating nickel oxalate by adjusting the pH of the solution formed in step (b) to a value ranging from 0.1 to 0.9 by adding a base, and
(d) separating the precipitated nickel oxalate from the remaining solution of step (c) by a solid, a liquid, or a solid and liquid separation,
wherein when the mixture of oxalates provided in step (a) comprises cobalt oxalate, the process further comprises the following steps:
(e) precipitating cobalt oxalate by adjusting the pH of the remaining solution from step (d) respectively of the solution formed in step (b) to a value ranging from 1 to 6 by adding a base, and
(f) separating the precipitated cobalt oxalate from the remaining solution of step (e) by solid/liquid separation,
wherein when the mixture of oxalates provided in step (a) comprises manganese oxalate, the process further comprises the following steps:
(g) precipitating a precipitate of one or more of manganese oxalate, manganese hydroxide and manganese oxide by adjusting the pH of the remaining solution from step (d) respectively (f) to a value ranging from 8 to 14.5 by adding a base, and
(h) separating the precipitate of one or more of manganese oxalate, manganese hydroxide and manganese oxide from the remaining solution of step (g) by solid/liquid separation.

2. The process according to claim 1, wherein separating a mixture of oxalates of Ni and Co comprises the steps of:
(a) providing a mixture of oxalates of Ni and Co,
(b) dissolving the mixture of oxalates in an acid to form a solution having a pH −0.5 or less,
(c) precipitating nickel oxalate by adjusting the pH of the solution formed in step (b) to a value ranging from 0.1 to 0.9 by adding a base,
(d) separating the precipitated nickel oxalate from the remaining solution of step (c) by solid/liquid separation,
(e) precipitating cobalt oxalate by adjusting the pH of the remaining solution of step (d) to a value ranging from 1 to 6 by adding a base,
(f) separating the precipitated cobalt oxalate from the remaining solution of step (e) by solid/liquid separation.

3. The process according to claim 1, wherein separating a mixture of oxalates of Ni and Mn comprises the steps of:
(a) providing a mixture of oxalates of Ni and Mn,
(b) dissolving the mixture of oxalates in an acid to form a solution with a pH of −0.5 or less,
(c) precipitating nickel oxalate by adjusting the pH of the solution formed in step (b) to a value ranging from 0.1 to 6 by adding a base,
(d) separating the precipitated nickel oxalate from the remaining solution of step (c) by solid/liquid separation,
(g) precipitating a precipitate of one or more of manganese oxalate, manganese hydroxide and manganese oxide by adjusting the pH of the remaining solution from step (d) to a value ranging from 8 to 14.5 by adding a base,
(h) separating the precipitate of one or more of manganese oxalate, manganese hydroxide and manganese oxide from the remaining solution of step (g) by solid/liquid separation.

4. The process according to claim 1, wherein separating a mixture of oxalates of Co and Mn comprises the steps of:
(a) providing a mixture of oxalates of Co and Mn,
(b) dissolving the mixture of oxalates in an acid to form a solution with a pH of -0.5 or less,
(e) precipitating cobalt oxalate by adjusting the pH of the solution formed in step (b) to a value ranging from 1 to 6 by adding a base,
(f) separating the precipitated cobalt oxalate from the remaining solution of step (e) by solid/liquid separation,
(g) precipitating a precipitate of one or more of manganese oxalate, manganese hydroxide and manganese oxide by adjusting the pH of the remaining solution from step (f) to a value ranging from 8 to 14.5 by adding a base; and
(h) separating the precipitate of one or more of manganese oxalate, manganese hydroxide and manganese oxide from the remaining solution of step (g) by solid/liquid separation.

5. The process according to claim 1, wherein step (b) comprises at least one of the following characteristics chosen from:
the mixture of oxalates is dissolved in an acid chosen from sulfuric acid, hydrochloric acid, and methanesulfonic acid;
the total concentration of Ni, Co and Mn in the solution formed in step (b) ranges from 1 g/l to 250 g/l;
the pH of the solution formed in step (b) ranges from −1 to −0.5;
in each of steps (c), (e) and (f), the pH is adjusted by adding a base independently chosen from LiOH, NaOH, KOH, and ammonia; and
in steps (d), (e) and (h), the solid/liquid separation is carried out by filtration, centrifugation, or sedimentation and decantation.

6. The process according to claim 1, wherein the process further comprises:
in step (b) the mixture of oxalates is dissolved by adding an aqueous solution of sulfuric acid having a concentration ranging from 20 wt % to 50 wt. % in an amount of from 20 ml to 100 ml per gram of the mixture of oxalates; and
in each of steps (c), (e) and (g), the pH is adjusted by adding an aqueous solution of NaOH or LiOH with a concentration ranging from 1 g/l to 500 g/l.

7. The process according to claim 1, wherein step (a) providing the mixture of oxalates of two or more of Ni, Co and Mn comprises the sub-steps of:
(aa) preparing an aqueous reaction mixture containing ions of two or more of Ni, Co and Mn and oxalate ions, wherein the aqueous reaction mixture has a pH ranging from 2 to 6,
(ab) reacting the aqueous reaction mixture to form a solid mixture of oxalates of two or more of Ni, Co and Mn, and
(ac) separating the formed solid mixture of oxalates of two or more of Ni, Co, and Mn from the remaining aqueous reaction mixture by solid/liquid separation.

8. The process according to claim 7, wherein substep (aa) preparing the aqueous reaction mixture comprises:
dissolving a mixture of two or more of Ni, Co and Mn in metallic form and/or in oxidized form in oxalic acid; or
adding oxalate ions to an aqueous solution comprising ions of two or more of Ni, Co and Mn,
wherein the solid material comprising a mixture of two or more of Ni, Co and Mn in metallic form and/or in oxidized form respectively, and the solution comprising ions of two or more of Ni, Co and Mn are obtained from used lithium ion batteries, from waste of the production of lithium ion batteries, from waste of the production of cells or components of lithium ion batteries, from waste of the production of cathode active materials for lithium ion batteries, or from combinations thereof.

9. The process according to claim 7, wherein one or more of the following steps occur:
in sub-step (aa), preparing the aqueous reaction mixture comprises adding a reducing agent;
in sub-step (aa), adjusting the pH of the aqueous reaction mixture to a value ranging from 2 to 6 by adding a base chosen from LiOH, NaOH, KOH, and ammonia; and
in sub-step (ab), reacting the aqueous reaction mixture for 8 to 16 hours under continuous stirring at a temperature ranging from 10° C. to 200° C. to form a solid mixture of oxalates of two or more of Ni, Co and Mn, wherein at temperatures above 100° C. the reaction is performed at a pressure higher than 101.3 kPa,
in sub-step (ac), carrying out the solid/liquid separation by filtration or centrifugation.

10. The process according to claim 7, wherein in sub-step (aa), the aqueous reaction mixture is formed by:
dissolving a mixture of two or more of Ni, Co and Mn in metallic form and/or in oxidized form in an acid chosen from sulfuric acid, hydrochloric acid, citric acid, and methanesulfonic acid;
optionally adding a reducing agent chosen from hydrogen peroxide, hydrazine, primary alcohols, ascorbic acid, glucose, starch, cellulose, alkali metal sulfites, and sulfurous acid;
heating to a temperature ranging from 50° C. to 98° C.;
after the mixture of two or more of Ni, Co and Mn in metallic form and/or in oxidized form is dissolved, adding an aqueous solution of oxalic acid, wherein the amount of oxalic acid is equimolar or in molar excess relative to the total molar amount of Ni, Mn and Co in the solution to form a solution containing oxalate ions and ions of two or more of Ni, Co and Mn; and
immediately adjusting the pH of the solution comprising oxalate ions and ions of two or more of Ni, Co and Mn to a value ranging from 2 to 6 by adding a base chosen from LiOH, NaOH, KOH, and ammonia.

11. The process according to claim 10, wherein the process further comprises one or more of the following:
dissolving a mixed oxide of two or more of Ni, Co and Mn by adding hydrochloric acid with a concentration ranging from 30 wt % to 40 wt. % in an amount of from 20 to 1000 times the solid mass;
adding an aqueous solution as the reducing agent, wherein the reducing agent comprises hydrogen peroxide with a concentration ranging from 1 wt % to 30 wt % in an amount from 0.2 vol % to 40 vol %, with respect to the volume of hydrochloric acid added for dissolving the mixed oxide;
forming an aqueous solution dissolving a mixed oxide of two or more of Ni, Co and Mn, wherein the total concentration of the dissolved Ni, Co and Mn ranges from 0.1 wt % to 20 wt %;
adding an aqueous solution of oxalic acid with a concentration ranging from 5 wt % to 30 wt % in an amount of from 105 mol % to 120 mol % oxalic acid relative to the molar amount of Ni, Mn and Co in the solution and the pH of the solution prior to the addition of the base ranges from −0.5 to 1; and
adding an aqueous solution of NaOH or LiOH with a concentration ranging from 1 g/l to 500 g/l to adjust the pH to a value ranging from 3 to 5.

12. The process according to claim 1, wherein the process further comprises the steps of
(i) mixing one or more of:
nickel oxalate obtained in step (d),
cobalt oxalate obtained in step (f), and
manganese oxalate, manganese oxide and manganese hydroxide obtained in step (h),
wherein with one or both of lithium carbonate and lithium hydroxide in a stoichiometric ratio corresponding to a mixed oxide of Li and one or more of Ni, Co and Mn and optionally with further constituents, and
(j) calcining the mixture to obtain a mixed oxide of Li and one or more of Ni, Co and Mn is obtained.

13. The process according to claim 12, wherein the mixed oxide has a composition according to the formula Li₁₊ₜ[CoₓMn_{y}Ni_{z}Mᵤ]₁₋ₜO₂, wherein
0≤x≤1
0≤y≤1
0≤z≤1
0≤u≤0.15
x+y+z+u=1
−0.05≤t≤0.2,
and wherein if M is present, M comprises one or more elements chosen from Al, Mg, Ba, B, and transition metals other than Ni, Co, and Mn.

14. The process according to claim 12, wherein the process further comprises one or more of the following steps:
in step (i), using lithium carbonate and/or lithium hydroxide obtained from used lithium ion batteries or from waste of the production of lithium ion batteries, cells and components of lithium ion batteries;
in step (j), calcining the mixture under oxygen atmosphere, un-der inert atmosphere, or under an atmosphere of a reducing gas; and
in step (j), calcining the mixture at temperature ranging from 300° C. to 900° C. for a duration of from 0.5 h to 20 h.
